(19) United States
(12) Patent Application Publication
(10) Pub. No.: US 2025/0330023 A1
(43) Pub. Date: Oct. 23, 2025

(54) Cabin Power Distribution Systems and Methods

(71) Applicant: Safran Passenger Innovations, LLC, Brea, CA (US)

(72) Inventors: Joseph Rhoads Winston, Yorba Linda, CA (US); Matthew Gledich, Mission Viejo, CA (US)

(73) Assignee: Safran Passenger Innovations, LLC, Brea, CA (US)

(21) Appl. No.: 18/860,584

(22) PCT Filed: Apr. 27, 2023
(86) PCT No.: PCT/US2023/020246

§ 371 Date: Oct. 25, 2024

Related U.S. Application Data
(60) Provisional application No. 63/336,983, filed on Apr. 29, 2022.
(60) Provisional application No. 17/814,008, filed on Jul. 21, 2022.

(51) Int. Cl. H02J 3/34; B64D 47/00

(52) U.S. Cl. CPC H02J 3/34; B64D 47/00; B64D 2221/00; H02J 2310/44

(57) ABSTRACT

Vehicle power distribution systems are described comprising one or more converter units in electrical communication with a vehicle power source. The converter unit is configured to receive a three-phase, high-frequency alternating current generated by the vehicle power source, and output a single phase or dual phase first current. Power outlets and/or data ports may be in electrical communication with the converter unit, such that they can receive the first current. The system may also have a simple power supply that can receive the first current and convert this to a second current, which can be used to power in-flight entertainment devices and other components of the vehicle.

This application claims priority to U.S. non-provisional patent application having Ser. No. 17/814,008 filed on Jul. 21, 2022, which itself claims priority to U.S. provisional patent application having Ser. No. 63/336,983 filed on Apr. 29, 2022. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is power distribution in vehicle cabins.

### BACKGROUND

The following description includes information that may be useful in understanding the present invention. It is not an admission that any of the information provided herein is prior art or relevant to the presently claimed invention, or that any publication specifically or implicitly referenced is prior art.

Aircraft power distribution systems generally rely on a power supply or box at each seat or seat group (e.g., seat row) to distribute power to one or more entertainment system units (e.g., a seat back, seat arm or monument unit), one or more alternating current (AC) power outlets, and/or one or more USB power outlets. As shown in FIGS. 1A-1B, power can be fed to one or more Advanced Master Control Units (AMCUs) 110, which then distribute power through multiple columns to a plurality of power supplies 120 distributed through the aircraft 102. The power is typically three-phase power at 115 VAC. The frequency can vary depending on the aircraft but is generally higher (e.g., 380-800 Hz) than the usable frequency of common Personal Electronic Devices (PEDs) (e.g., 50-60 Hz).

Each of the power supplies 120 can reduce the voltage and/or frequency of the received power as needed, depending on the application. For example, the power supply 120 can feed power to one or more AC power outlets 130 at a reduced voltage of 110 VAC and a frequency of 50 Hz, while also converting some of the received power to direct current (DC) at a voltage between 5-28 VDC when distributing to one or more USB power outlets 132 and/or one or more entertainment system units 134. The power supply 120 can also supply power to one or more light sources 136 that may indicate a status of the A/C power outlet 130, the USB port 132 and/or the seat group level, as well as other components of the aircraft.

Power supply 120 offers galvanic isolation but generally requires power input testing since it is connected directly to the aircraft power system. In addition, the requirement for larger power supplies at each seat group increases the overall volume and weight requirements of the system.

Thus, there is still a need for improved power distribution systems that eliminate the need for seat/row-specific power supplies or reduce the overall volume of the seat/row-specific power supplies when entertainment units, USB outlets, and/or A/C outlets are utilized at seat locations.

### SUMMARY OF THE INVENTION

The inventive subject matter provides apparatus, systems, and methods for power distribution within an aircraft or other vehicle which can be used to power a plurality of power outlets or various components of the vehicle. While the below discussion is directed to an aircraft, it is contemplated that other vehicles could utilize the inventive subject matter discussed herein, including, for example, busses, trains, cars, ferries, and so forth, where a high-frequency alternating current must be distributed to a plurality of power outlets and other components which require a lower alternating current frequency and/or a direct current for use by passengers or crew.

It is contemplated that the power outlets could be used to power one or more portable electronic devices of passengers or crew. As used herein, the term “portable electronic device” is defined to include laptop computers, tablet PCs, mobile phones including, for example, those running APPLE iOS™ or ANDROID™ operating software, smart watches, smart glasses such as GOOGLE glass or their equivalent capable of displaying augmented reality elements to a user wearing the glasses.

Contemplated power distribution systems for a vehicle comprises a converter unit in electrical communication with an aircraft power source and configured to receive an aircraft current from the aircraft power source. The aircraft current generally comprises a three-phase, high-frequency alternating current having a first frequency, and is typically generated by one or more engines of the aircraft. It is contemplated that the frequency of the aircraft current may be between 300-1000 Hertz.

The converter unit described herein preferably generates and outputs a single phase or dual phase first current in response to the aircraft current. It is preferred that the first current comprises a second frequency that is less than the first frequency. It is also preferred that the first current and the aircraft current each have a voltage between 100-122 VAC. It is especially preferred that the converter unit described herein provides phase balancing of the input aircraft current to prevent overloading downstream in the system. Such phase balancing generally does not occur in prior art power distribution systems for vehicles. Instead, such systems typically utilize phase rotation in the cables, which often leads to situations where every third seat group is heavily loaded (meaning one of the three phases is overloaded). This phase imbalance causes the generator control unit (GCU) difficulty and may cause the circuit to trip.

The first current preferably comprises a single or dual phase alternating current having a fixed frequency. It is contemplated that the output of the first current can be constructed to either be line-to-line or line-to-neutral.

One or more power outlets are preferably in electrical communication with the converter unit, wherein the power outlets are configured to receive the first current. As discussed above, the power outlets can be used by passengers, crew, or otherwise to provide power to one or more portable electronic devices or other devices or components that can be charged or otherwise powered using the power outlets. In some embodiments, the power outlets can receive the first current which has a voltage of 110 VAC and a frequency of 50 Hz. Of course, the specific voltage and frequency may vary depending on the application.

Advantageously, a separate power supply is not required near or at the seat or other location where the power outlet is disposed to provide power from the converter unit to the power outlet, which can greatly reduce the volume and weight required for power distribution within the aircraft or other vehicle. Instead, appropriate power can be fed directly to the power outlets.

In some embodiments, the power outlets comprise intelligent AC power outlet units (ACOUs). In such embodiments, it is contemplated that direct current power can be generated by the ACOU, rather than a separate power supply, when a USB or alternative power port is required. This provides for a great simplification of the development and regulatory approval process for the system and may eliminate the need for any major in-floor wiring changes to some vehicle's architecture.

In other embodiments, a simple seat-centric or seat-group centric power supply (simple power unit) can be disposed at a seat group within the vehicle. The simple power supply is configured to receive the first current from the control unit and monitor/distribute the first current to a plurality of devices. Thus, in such embodiments, and unlike prior art systems, the simple power supply does not convert the first current for an ACOU, eliminating the conversion function at the seat group. In some embodiments, the simple power supply may provide device protection by utilizing GFCI, over/under current monitoring, under/over voltage monitoring, and/or allow for disabling of current flow based on signal received from a distribution unit or other component.

One or more aircraft devices can be in electrical communication with the simple power supply and configured to receive the second current from the simple power supply. In such embodiments, it is contemplated that the first current is different than the second current. For example, the voltage of the second current is preferably less than the voltage of the first current. As another example, the second current may comprise a direct current having a voltage of less than 50 VDC. In some embodiments, the second current may comprise a direct current having a voltage of less than 48 VDC or less than 42 VDC. In still further embodiments, the second current may comprise a direct current having a voltage of approximately 28 VDC while the first current may comprise an alternating current having a voltage of approximately 110-120 VAC and a frequency between 30-60 hertz.

The aircraft devices may comprise a universal serial bus (USB) port, an in-use light, an entertainment system, or combinations thereof. Entertainment systems may include a seat, seat-arm, or monument display unit having a display screen configured to display content to a passenger, for example.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a schematic of a prior art power distribution system.

FIG. 1B is a schematic of another prior art power distribution system.

FIG. 2 is a schematic of one embodiment of a power distribution system.

FIG. 3 is a schematic of another embodiment of a power distribution system.

FIG. 4 is a schematic of another embodiment of a power distribution system.

FIG. 5 is a schematic of another embodiment of a power distribution system.

FIG. 6 is a schematic of another embodiment of a power distribution system.

FIG. 7 is a schematic of another embodiment of a power distribution system.

FIG. 8 is a schematic of another embodiment of a power distribution system.

### DETAILED DESCRIPTION

Throughout the following discussion, references may be made regarding servers, services, interfaces, portals, platforms, or other systems formed from electronic devices. It should be appreciated that the use of such terms is deemed to represent one or more electronic devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations and permutations of A, B, C, or D, even if not explicitly disclosed.

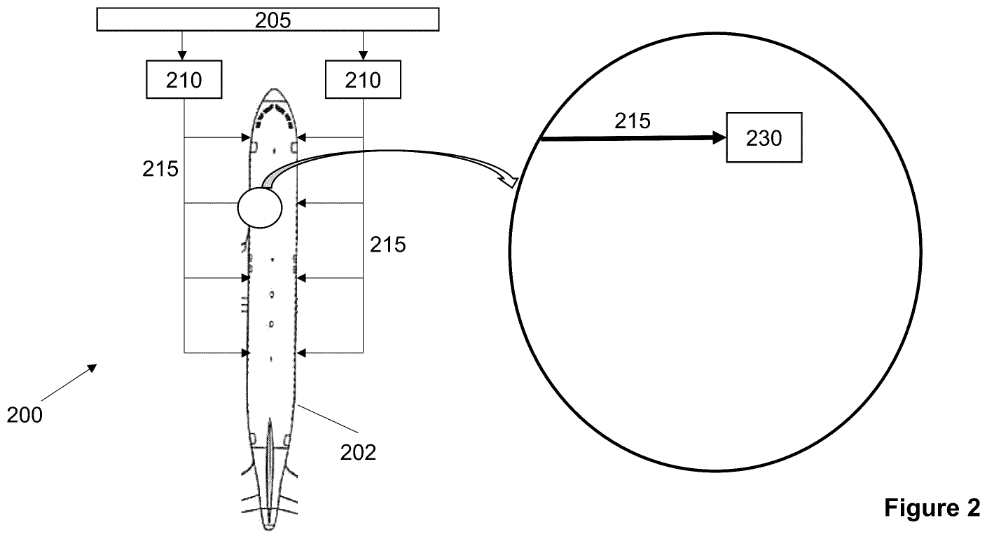

FIG. 2 illustrates one embodiment of a power distribution system 200 for an aircraft 202. Aircraft power can be distributed to one or more converter units 210 from an aircraft power source providing an aircraft current 205. Each converter unit 210 may represent a column for power distribution within the aircraft. In some embodiments, the aircraft current 205 comprises a three-phase, high-frequency alternating current at a nominal voltage of between 100-122 VAC, and more preferably 115 VAC. The specific frequency will likely vary depending on the aircraft or other vehicle, but may range between 300-1,000 Hz, and more preferably between 350-850 Hz.

The converter units 210 are in electrical communication with the aircraft power source. The converter units 210 are configured to receive the aircraft current 205 and output a first current 215 in response to the aircraft current. The first current 215 is preferably single phase or dual phase power having a fixed frequency that is less than the frequency of the aircraft current 205. In some embodiments, the converter units 210 ensure the aircraft current 205 and the first current 215 are in galvanic isolation from one another.

As shown in FIG. 2, the first current 215 can be distributed throughout the aircraft along one or more columns directly to a plurality of power outlets 230 without the need for a separate power supply at each seat or seat group. Each power outlet 230 is in electrical communication with one of the converter units 210 such that each of the power outlets 230 receives the first current 215. It is preferred that each seat row of the aircraft 202 may have at least one power outlet 230. Thus, for an aircraft having thirty rows of seats, it is contemplated that there may be thirty, sixty, or more power outlets 230 disposed within the vehicle 202, depending on the number of power outlets 230 disposed at each seat row or group.

It is preferred that the first current 215 comprises an alternating current having a voltage of between 110-120 VAC at a frequency of between 30-60 HZ, and more preferably, between 50-60 Hz. Of course, the specific properties of the current may vary depending on the application.

The power outlets can be used, for example, to power and/or charge portable electronic devices such as those described above.

Although the above description has referenced aircraft, it is contemplated that the power distribution system 200 could be implemented in other vehicles such as those described above.

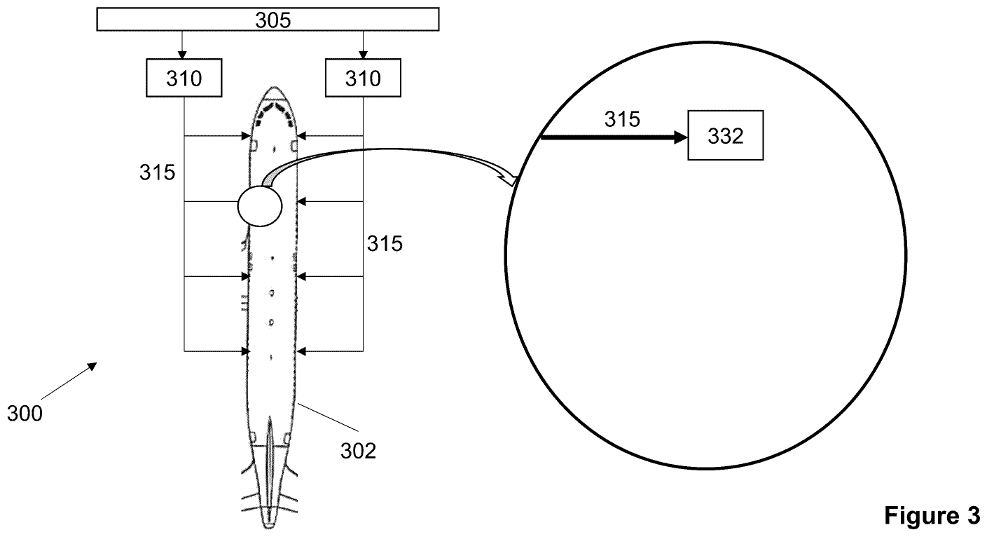

FIG. 3 illustrates another embodiment of a power distribution system 300 for an aircraft 302. Similar to FIG. 2, aircraft power can be distributed to one or more converter units 310 that are in electrical communication with an aircraft power source providing an aircraft current 305. It is contemplated that the aircraft current 305 comprises a three-phase, high-frequency alternating current having the same properties as described above with respect to FIG. 2. The converter units 310 are configured to receive the aircraft current 305 and output a single phase or dual phase first current 315 in response to the aircraft current 305. In some embodiments, the converter units 310 ensure the aircraft current 305 and the first current 315 are in galvanic isolation from one another.

The first current 315 can be distributed throughout the aircraft to a plurality of power outlets 332, which may comprise one or more universal serial bus (USB) or other data or power ports that are in electrical communication with one of the converter units 310 such that power outlets 332 receive the first current 315 without the need for a separate power supply at each seat or seat group. It is preferred that each seat row or group of the aircraft 302 may have at least one power outlets 332, and in some cases, each seat may include at least one power outlets 332. It is preferred that the first current 315 preferably comprises a direct current having a voltage of less than 50 VDC. In some embodiments, the first current 315 may comprise a direct current having a voltage of approximately 28 VDC. Of course, the specific properties of the current may vary depending on the application.

In some embodiments, the first current 315 can be distributed rail-to-rail, with a positive source wire and a negative return wire. In one such embodiment, the first current 315 has a voltage of ±28 VDC, with the positive wire or rail having a voltage of +28 VDC and the negative wire or rail having a voltage of −28 VDC.

In other embodiments, the first current 315 can be distributed line-to-neutral.

Although the above description has referenced aircraft, it is contemplated that the power distribution system 300 could be implemented in other vehicles such as those described above.

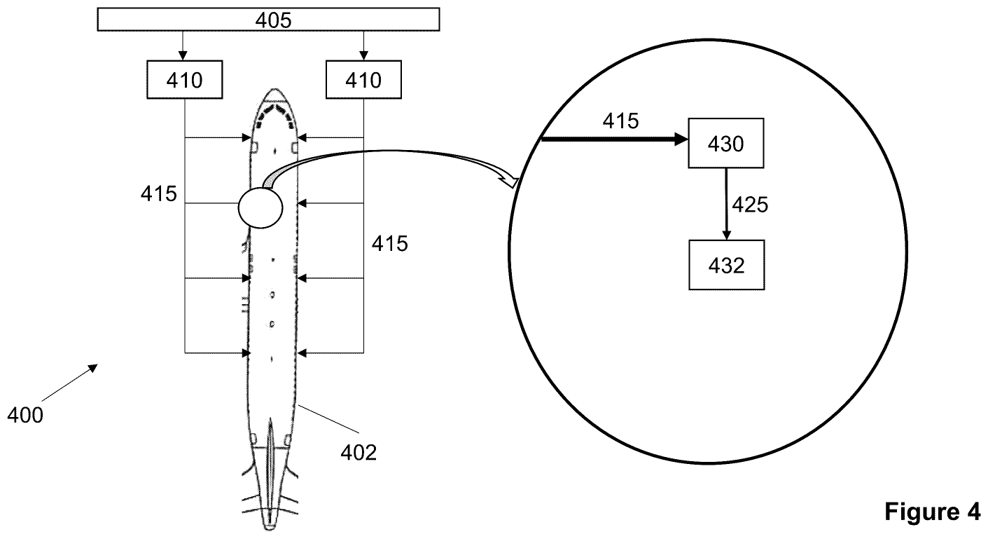

FIG. 4 illustrates another embodiment of a power distribution system 400 for an aircraft 402. Aircraft power can be distributed to one or more converter units 410 that are in electrical communication with an aircraft power source providing an aircraft current 405. It is contemplated that the aircraft current 405 comprises a three-phase, high-frequency alternating current having the same properties as described above. The converter units 410 are configured to receive the aircraft current 405 and output a first current 415 comprising single phase or dual phase power in response to the aircraft current 405. It is contemplated that the converter units 410 may ensure the aircraft current 405 and the first current 415 are in galvanic isolation from one another.

The first current 415 can be distributed throughout the aircraft to (i) a plurality of power outlets 430 that are in electrical communication with one of the converter units 410 and (ii) a plurality of data or power ports 432 that are in electrical communication with one of the converter units 410, such that both the plurality of power outlets 430 and the plurality of data or power ports 432 receive the first current 415 without the need for a separate power supply at each seat or seat group. Each seat or seat row/group of the aircraft 402 may have at least one data or power port 432 and/or at least one power outlet 430. As shown, the first current 415 preferably comprises an alternating current with a voltage of 110-120 VAC at a frequency of approximately 50 Hz. Of course, the specific properties of the current may vary depending on the application.

In some contemplated embodiments, at least some of the power outlets 430 may comprise ACOUs, which can convert the received alternating current into direct current for use by USB or other data ports 432, inductive charging, or otherwise. In such embodiments, the first current 415 would be received by one or more of the ACOUs, which would convert the received first current 415 into a second current 425 that is received by the data ports 432. In such embodiments, it is contemplated that the second current 425 comprises a direct current with a voltage less than 50 VDC. In some embodiments, the second current 425 may comprise a direct current having a voltage of less than 48 VDC or less than 42 VDC. In still further embodiments, the second current 425 may comprise a direct current having a voltage of approximately 28 VDC, although the specific properties of the current may vary depending on the application.

Although the above description has referenced aircraft, it is contemplated that the power distribution system 400 could be implemented in other vehicles such as those described above.

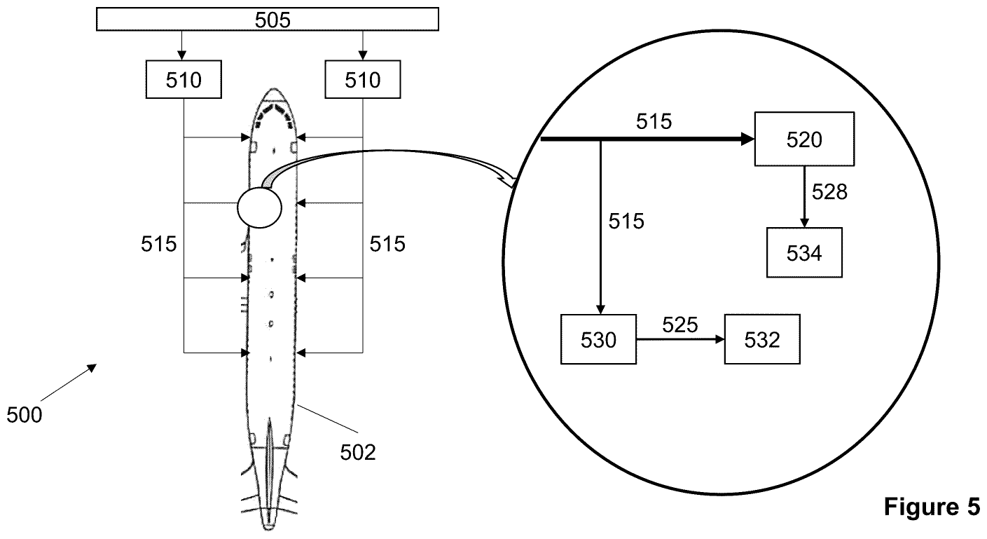

FIG. 5 illustrates another embodiment of a power distribution system 500 for an aircraft 502. Aircraft power can be distributed to one or more converter units 510 that are in electrical communication with an aircraft power source providing an aircraft current 505. It is contemplated that the aircraft current 505 comprises a three-phase, high-frequency alternating current having the same properties as described above. The converter units 510 are configured to receive the aircraft current 505 and output a single phase or dual phase first current 515 in response to the aircraft current 505.

In some embodiments, the converter units 510 ensures the aircraft current 505 and the first current 515 are in galvanic isolation from one another. In this manner, the galvanic isolation point can be moved from a local power supply disposed at the seat or seat group to a central converter unit 510.

The first current 515 can be distributed throughout the aircraft to (i) a plurality of power outlets 530 that are in electrical communication with one of the converter units 510 and (ii) a plurality of data or power ports 532 that are in electrical communication with one of the converter units 510, such that both the plurality of power outlets 530 and the plurality of data or power ports 532 receive the first current 515. Each seat or seat row/group of the aircraft 502 may have at least one data or power port 532 and/or at least one power outlet 530. As shown, the first current 515 preferably comprises an alternating current with a voltage of 110-120 VAC at a frequency of approximately 50 Hz. Of course, the specific properties of the current may vary depending on the application.

In some embodiments, at least some of the power outlets 530 may comprise ACOUs, which can convert the received alternating current into direct current (a second current) 525 for use by USB or other data ports 532, inductive chargers, or otherwise. In such embodiments, the first current 515 is received by the power outlets 530, which could convert the received first current 515 into the second current 525 that is received by the data ports 532. In such embodiments, it is contemplated that the second current 525 may comprise a direct current having a voltage of less than 50 VDC. In some embodiments, the second current 525 may comprise a direct current having a voltage of less than 48 VDC or less than 42 VDC. In still further embodiments, the second current 525 may comprise a direct current having a voltage of approximately 28 VDC, although the specific properties of the current may vary depending on the application.

In vehicles having components 534 of an in-flight or in-vehicle entertainment system requiring power at seatbacks or other locations within the vehicle, for example, it is contemplated that the first current 515 can further be distributed to one or more simply power units or power supplies 520, which can be used to convert the first current 515 to a second current 525. In the embodiment shown in FIG. 5, the simple power supply 520 converts the first alternating current 515 to a third direct current 528 having a voltage of less than 50 VDC, and in some embodiments, 28 VDC. This direct current can then be used to power the in-flight entertainment component 534, which may comprise a seat back unit (SBU) having a display screen for displaying content to a passenger. The power supply 520 could power other devices or components as needed (including the USB or other data ports 532), especially those requiring a direct current at a lower voltage.

It is contemplated that the power supply 520 may ensure the first current 515 and the third current 528 are in galvanic isolation from one another.

Although the above description has referenced aircraft, it is contemplated that the power distribution system 500 could be implemented in other vehicles such as those described above.

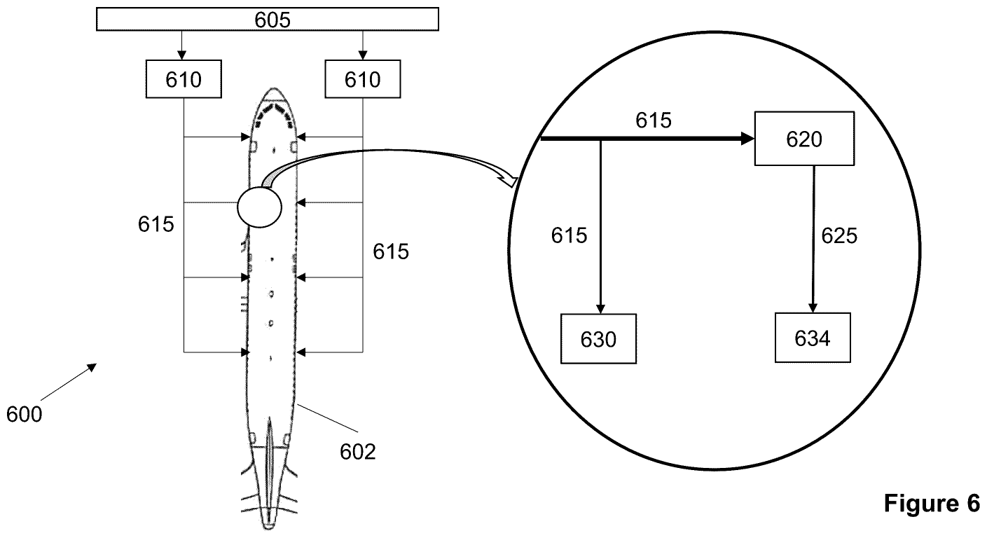

FIG. 6 illustrates another embodiment of a power distribution system 600 for an aircraft 602. The system 600 is similar to that shown in FIG. 5 except that the power distribution system 600 does not directly provide power to universal serial bus (USB) or other data ports.

As in the above systems, aircraft power can be distributed to one or more converter units 610 that are in electrical communication with an aircraft power source providing an aircraft current 605. It is contemplated that the aircraft current 605 comprises a three-phase, high-frequency alternating current having the same properties as described above. The converter units 610 are configured to receive the aircraft current and output a single phase or dual phase first current 615 in response to the aircraft current 605. It is contemplated that the converter units 610 may ensure the aircraft current 605 and the first current 615 are in galvanic isolation from one another.

The first current 615 can be distributed throughout the aircraft 602 to a plurality of power outlets 630 with the aircraft 602 and that are in electrical communication with one of the converter units 610, such that the plurality of power outlets 630 receives the first current 615. It is contemplated though not required that each seat or seat row/group of the aircraft 602 have at least one power outlet 630. As shown, the first current 615 preferably comprises a single or dual phase power having an alternating current with a voltage of 110-120 VAC at a frequency of approximately 50 Hz. Of course, the specific properties of the first current 615 may vary depending on the application.

Similar to system 500 shown in FIG. 5, the power distribution system 600 can further be distributed to one or more simply power units or supplies 620, which can be used to convert the first current 615 to a second current 625. The simple power supply 620 converts the alternating first current 615 to a direct current (second current 625) having a voltage of less than 50 VDC and, in some embodiments, 28 VDC, which can be used to power various components of the aircraft 602 including in-flight entertainment components 634 or in-vehicle entertainment systems that may comprise a seat back unit (SBU) having a display screen for displaying content to a passenger, for example.

Although the above description has referenced aircraft, it is contemplated that the power distribution system 600 could be implemented in other vehicles such as those described above.

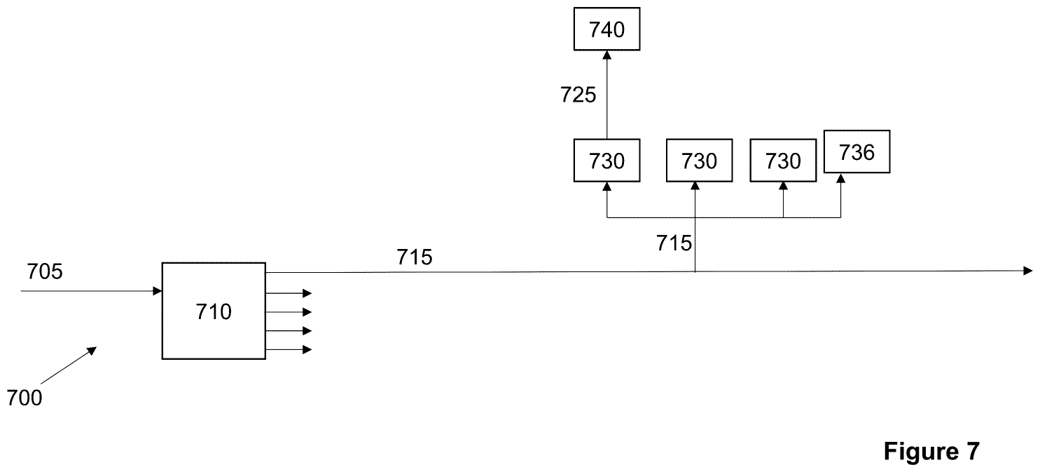

FIG. 7 illustrates another embodiment of a power distribution system 700 for a vehicle. As shown, power can be distributed to at least one converter unit 710 that is in electrical communication with a vehicle power source providing a vehicle current 705. It is contemplated that the power source can output a vehicle current 705 comprising a three-phase power at approximately 115 VAC. In some embodiments, it is contemplated that the vehicle current 705 has a high frequency of between 300-1000 Hz. However, the specific frequency and the voltage will depend on the vehicle and other factors.

The converter unit 710 is configured to receive the vehicle current 705 and output a first current 715. It is contemplated that the vehicle current 705 and the first current 715 are in galvanic isolation from one another. In some embodiments, the first current 715 could have a voltage of approximately 110 VAC with a frequency of between 30-60 Hz, and preferably at approximately 50 Hz. Of course, the specific properties of the first current 715 may vary depending on the application. The converter unit 710 preferably produces a single or dual phase power using tri-state discrete logic.

The first current 715 can be distributed along multiple columns throughout the vehicle to a plurality of power units 730 that each comprise one or more outlets. In some contemplated embodiments, each power unit 730 could comprise a standard plug outlet (e.g., US or European standard outlets) as well as including one or more USB or other data or power ports.

In some embodiments, the converter unit 710 or a separate control unit can provide for a master system cutoff of power to individual power units 730, provide configurable current limits, and/or GFI protection, for example. In one embodiment, the converter unit 710 or a control unit is configured to receive the first current 715 from the control unit and enable or disable a flow of the first current 715 to one or more of the power units 730 based on one or more factors. Such factors may include, for example, whether a plug is inserted into an outlet of the power unit 730, whether a voltage of the first current 715 exceeds a first threshold or is less than a second threshold, and whether the first current 715 exceeds a first threshold or is less than a second threshold.

In other embodiments, the converter unit 710 or a separate control unit can receive inputs from an operator or another system of the vehicle, and is configured to enable or disable the first current 715 to one or more of the power units 730 based on the received input.

In still other embodiments, the converter unit 710 or a separate control unit is configured to implement a tri-state control of the power units 730, wherein the three states applied to the power units 730 comprise an enabled mode, a restricted mode, and a disabled mode. In an enabled mode, current flows to the power unit 730 and the power unit 730 can be used to power a device, for example. In a restricted mode, current continues to flow to the power units 730 that have been drawing power, but power units 730 not in use are disabled (or current flow to them is prevented). In a disabled mode, all power units 730 are disabled (or current flow to them is prevented).

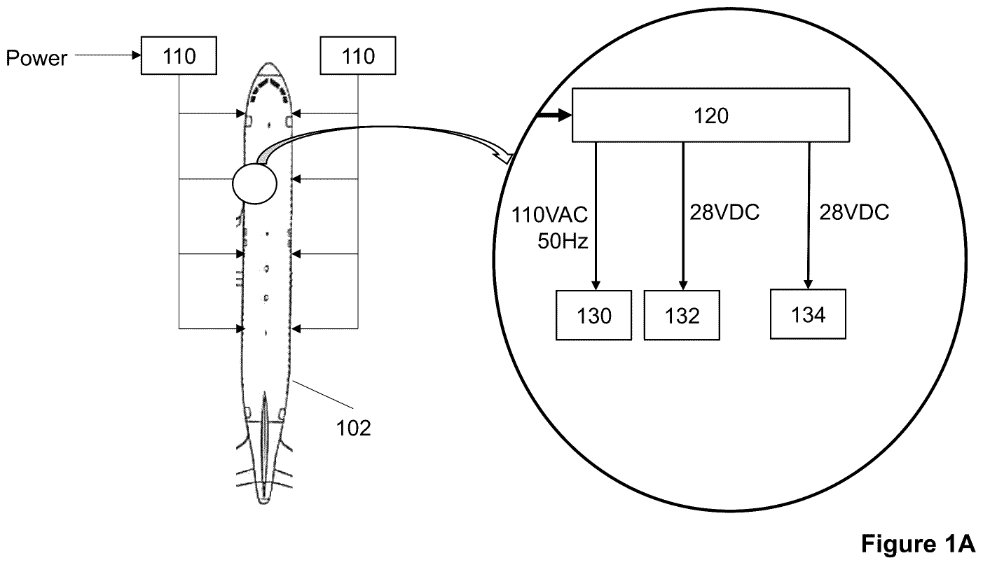

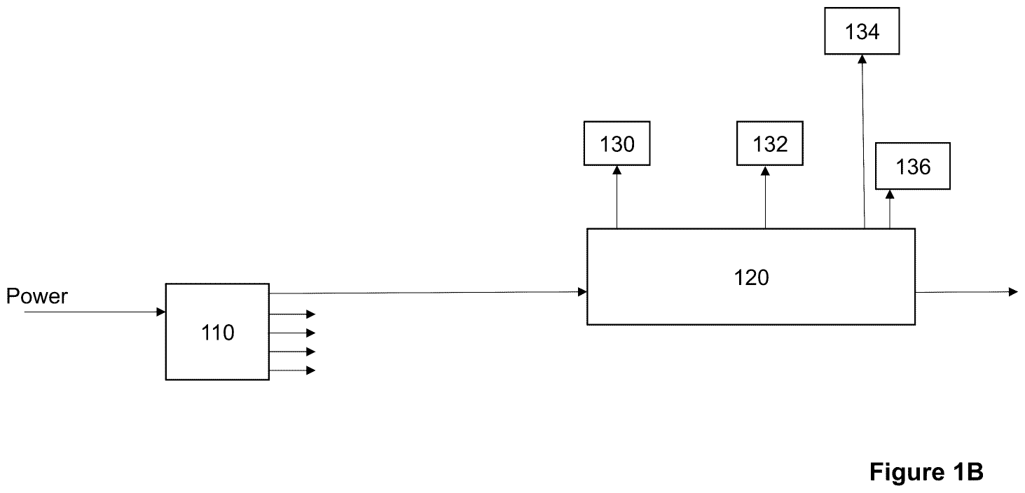

Advantageously, each power unit 730 can be configured to convert the received alternating first current 715 to a second current 725. The second current 725 preferably comprises a direct current that can be used to power devices plugged into a USB or other port 740. This eliminates the need for a separate power supply at each seat group such as shown in FIGS. 1A-1B, which would otherwise be needed to convert the incoming current. It is contemplated that the second current 725 could have a voltage of less than 50 VDC. In some embodiments, the second current may have a voltage of less than 48 VDC or less than 42 VDC. In still further embodiments, the second current may have a voltage of approximately 28 VDC.

The first current 715 can further be used to power one or more in-use lights 736 or other components of the vehicle. The in-use lights (IUL) can be used to indicate a status of the power unit 730, the USB or other ports, and/or the seat-group level, for example.

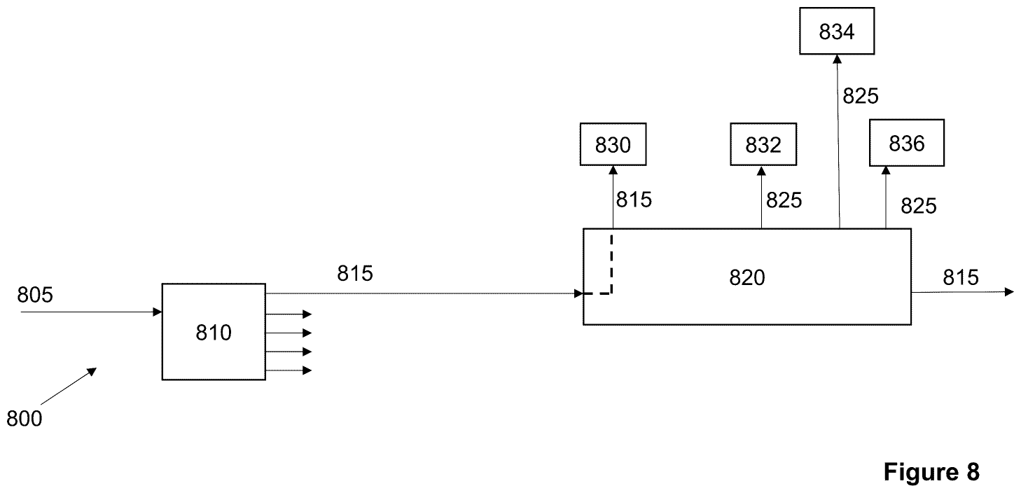

In an alternative embodiment shown in FIG. 8, another embodiment of a power distribution system 800 is shown. An in-line power can be distributed to one or more converter units 810 that are in electrical communication with a vehicle power source providing a vehicle current 805. In some embodiments, it is contemplated that the vehicle current 805 comprises a voltage of between 100-122 VAC with a high-frequency between 300-1,000 Hz and more preferably, between 350-850 Hz. Of course, the specific voltage and frequency will depend on the specific application.

The converter units 810 are configured to receive the vehicle current 805 and output a first current 815 in response to the vehicle current 805. It is contemplated that the converter units 810 ensures the vehicle current 805 and the first current 815 are in galvanic isolation from one another. In some embodiments, the first current 805 preferably comprises an alternating current with a voltage of between 110-120 VAC at a frequency of approximately 50 Hz. Of course, the specific properties of the current may vary depending on the application.

In some embodiments, the converter unit 810 or a control unit can provide for a master system cutoff of power to the individual seats or seat groups (such as individual power outlets), configurable current limits, and/or GFI protection, for example. In addition, the converter unit 810 can produce single or dual phase power using tri-state discrete logic.

The first current 815 can be distributed throughout the aircraft to one or more simple power units 820, which may be disposed at each seat group of the vehicle. Each simple power unit 820 can be configured to distribute the first current 815 to one or more ACOUs while monitoring the first current. Thus, in such embodiments, and unlike prior art systems, the one or more simple power units 820 do not convert the first current for the ACOU, eliminating the conversion function at the seat group. In some embodiments, the one or more simple power units 820 may provide device protection by utilizing GFCI, over/under current monitoring, under/over voltage monitoring, and/or allow for disabling of current flow based on signal received from a distribution unit or other component.

The simple power unit 820 allows for the pass through of the first current 815 without conversion to allow the first current 815 to be distributed to a plurality of power outlets 830 (ACOUs) that are in electrical communication with one of the converter units 810. The ACOU 830 may process and convert the first current 815 to a second current 825, as needed. For example, the ACOU 830 may convert the first current 815 to a lower voltage and/or to a direct current for use by one or more USB or other data ports 832, which may not operate at the first current 815. In some embodiments, the ACOU 830 may convert the first current 815 to a direct current (second current 825) with a voltage of less than 50 VDC and, in some embodiments 28 VDC, with some holdup time. Power to the one or more USB or other data ports 832 may also be supplied as a direct current with a voltage of 28 VDC with no holdup or other voltages that are less than 50 VDC. It is contemplated that the data ports 832 may be controlled and operated via the tri-state circuity.

The second current 825 can further be used to power one or more entertainment units 834, in-use lights 836 or other components of the vehicle. The in-use lights (IUL) can be used to indicate a status of the power unit 830, the USB or other port, and/or the seat-group level, for example.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A vehicle power distribution system, comprising:
an aircraft power source providing an aircraft current, wherein the aircraft current is a three-phase, high-frequency alternating current having a first frequency from a power source;
a converter unit configured to receive the aircraft current and to generate a single phase first current, and wherein the first current comprises a second frequency that is less than the first frequency, and wherein the converter unit is configured to provide phase balancing of the input current; and
a plurality of power outlets in electrical communication with the converter unit, wherein the plurality of power outlets is configured to receive the first current.

2. The vehicle power distribution system of claim 1, wherein the three-phase, high-frequency alternating current and the first current each have a voltage between 100-122 VAC.

3. The vehicle power distribution system of claim 1, wherein the first current comprises a single phase, alternating current having a fixed frequency.

4. The vehicle power distribution system of claim 1, wherein the first current comprises a dual phase, alternating current having a fixed frequency.

5. The vehicle power distribution system of claim 1, wherein the output of the converter unit is constructed to be line-to-line.

6. The vehicle power distribution system of claim 1, wherein the output of the converter unit is constructed with a neutral return.

7. The vehicle power distribution system of claim 1, wherein the first frequency is between 300-1,000 hertz and the second frequency is between 30-60 hertz.

8. The vehicle power distribution system of claim 1, wherein the second frequency is approximately 60 hertz.

9. The vehicle power distribution system of claim 1, wherein the first current is received by the power outlets.

10. The vehicle power distribution system of any of claim 9, wherein the power outlet comprises an AC power outlet, a universal serial bus port, or an inductive charger.

11. (canceled)

12. The vehicle power distribution system of claim 1, further comprising:
a control unit configured to receive the first current from the converter unit and enable or disable a flow of the first current to the power outlet based on one or more factors.

13. The vehicle power distribution system of claim 12, wherein the control unit is configured to receive a signal that a plug is detected in the power outlet.

14. The vehicle power distribution system of claim 12, wherein the control unit is configured to monitor the first current and disable the flow of the first current to the power outlet if a voltage of the first current exceeds a first threshold or is less than a second threshold.

15. The vehicle power distribution system of claim 12, wherein the control unit is configured to monitor the first current and disable the flow of the first current to the power outlet if the first current exceeds a first threshold or is less than a second threshold.

16. The vehicle power distribution system of claim 12, wherein the control unit is configured to receive an input from an operator or another system of the vehicle, and wherein the controller is configured to enable or disable a flow of the first current to the power outlet based the input.

17. The vehicle power distribution system of claim 12, wherein the control unit is configured to implement a tri-state control of the power outlet, wherein the three states applied to the power outlet comprise an enabled mode, a restricted mode, and a disabled mode.

18. The vehicle power distribution system of claim 1, further comprising:
a power supply disposed at a seat group configured to receive first current and output a second current in response to the first current;
an aircraft device in electrical communication with the power supply, wherein the aircraft device is configured to receive power from the second current, and wherein the first current is different than the second current, and wherein the second current comprises a direct current.

19. (canceled)

20. The vehicle power distribution system of claim 18, wherein the first current comprises a frequency between 30-60 hertz and a voltage between 110-120 VAC, and wherein the second current comprises a voltage of less than 50 VDC.

21. The vehicle power distribution system of claim 18, wherein the first current and the second current are in galvanic isolation from one another.

22. The vehicle power distribution system of claim 18, wherein the aircraft device comprises a universal serial bus port, an in-use light, or an in-flight entertainment system.
